(19) United States
(12) Patent Application Publication
(10) Pub. No.: US 2026/0141700 A1
(43) Pub. Date: May 21, 2026

(54) METHOD AND SYSTEM FOR REDUCING HALLUCINATIONS GENERATED BY A LARGE VISION-LANGUAGE MODEL

(71) Applicants: INVENTEC (PUDONG) TECHNOLOGY CORPORATION, Shanghai (CN); INVENTEC CORPORATION, Taipei City (TW)

(72) Inventors: Jeng-Lin LI, Taipei City (TW); Po Hsuan HUANG, Taipei City (TW); Chin-Po CHEN, Taipei City (TW); Ming-Ching CHANG, Taipei City (TW); Wei-Chao CHEN, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 19/240,587

(22) Filed: Jun. 17, 2025

(30) Foreign Application Priority Data
Nov. 18, 2024 (CN) 202411651839.1

(51) Int. Cl. G06V 10/776; G06F 40/40; G06V 10/764

(52) U.S. Cl. CPC G06V 10/776; G06F 40/40; G06V 10/764

(57) ABSTRACT

A method and system for reducing hallucinations generated by a Large Vision-Language Model (LVLM) are provided. The method includes a plurality of steps performed by a computing device, and these steps include: obtaining a test image, inputting the test image and a prompt into the LVLM to generate a test embedding, where the prompt instructs the LVLM to describe the test image, identifying a candidate embedding closest to the test embedding among a plurality of reference embeddings, replacing data of the test embedding in a salient dimension with data of the candidate embedding in the salient dimension, and generating a test result by the LVLM according to the test embedding with replaced data.

### CROSS-REFERENCE TO RELATED APPLICATIONS

This non-provisional application claims priority under 35 U.S.C. § 119(a) on Patent Application No(s). 202411651839.1 filed in China on Nov. 18, 2024, the entire contents of which are hereby incorporated by reference.

### BACKGROUND

### 1. Technical Field

The present disclosure relates to large vision-language models (LVLMs), and more particularly to a method and system for reducing hallucinations generated by LVLM.

### 2. Related Art

Large vision-language model (LVLM) possesses powerful capabilities to comprehend multimodal data and respond to human commands. Alongside advancements in network architectures, significant research focuses on improving response accuracy and reducing deviations from human instructions. Despite these efforts, modern LVLMs struggle with real-world challenges due to their notorious hallucinations that jeopardize downstream reliability and safety.

LVLM hallucinations occur when the generated contents do not align with the provided visual cues or include unrelated or incorrect texts. Mitigating hallucinations by fine-tuning LVLMs with human preferences is effective but expensive, requiring extensive human annotations. Alternatively, approaches that require LVLMs to iteratively answer multiple verification questions incur significant computational overhead.

### SUMMARY

In view of the above, the present disclosure provides a method and system for reducing hallucinations generated by LVLM.

According to one or more embodiment of the present disclosure, a method for reducing hallucinations generated by a large vision-language model includes a plurality of steps performed by a computing device. The plurality of steps includes: obtaining a test image; inputting the test image and a prompt into the large vision-language model to generate a test embedding, wherein the prompt is configured to instruct the large vision-language model to describe the test image; identifying, among a plurality of reference embeddings, a candidate embedding closest to the test embedding; replacing data of the test embedding in a salient dimension with data of the candidate embedding in the salient dimension; and generating a test result by the large vision-language model according to the test embedding with replaced data.

According to one or more embodiment of the present disclosure, a system for reducing hallucinations generated by a large vision-language model includes a storage device and a computing device. The storage device is configured to store a test image, a large vision-language model, and a plurality of reference embeddings. The computing device is electrically connected to the storage device, wherein the computing device is configured to input the test image and a prompt into the large vision-language model to generate a test embedding, the prompt is configured to instruct the large vision-language model to describe the test image, the computing device is further configured to identify, among the plurality of reference embeddings, a candidate embedding closest to the test embedding, to replace data of the test embedding in a salient dimension with data of the candidate embedding in the salient dimension, and to generate a test result by the large vision-language model according to the test embedding with replaced data.

In summary, the present disclosure proposes a method and system aimed at reducing hallucination in LVLMs in an efficient manner without model retraining and iterative inferencing. The present disclosure blocks the effects of hallucinatory triggers by intervention of the causal graph. This intervention is implemented as a replacement of the partial inputs, this intervention barely increases the inference time. The method and system proposed by the present disclosure directly intervenes the identified aspects of hallucination triggers, and thus mitigates hallucinatory object detection and multiple rounds of repeated generation. In contrast to previous works that focusing on eliminating the generated hallucinatory objects, the present disclosure captures the potential influential sources to hallucination and changes the generation process beforehand.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of a system for reducing hallucinations generated by a large vision-language model according to an embodiment of the present disclosure;

FIG. 2 is a flowchart of a method for reducing hallucinations generated by a large vision-language model according to an embodiment of the present disclosure;

FIG. 3 is a flowchart for generating reference embeddings according to an embodiment of the present disclosure;

FIG. 4 is a schematic diagram of the ideal output of a large vision-language model;

FIG. 5 is a causal graph model when a large vision-language model generates hallucinations; and

FIG. 6 to FIG. 8 respectively correspond to three intervention embodiments proposed by the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present disclosure. The following embodiments further illustrate various aspects of the present disclosure, but are not meant to limit the scope of the present disclosure.

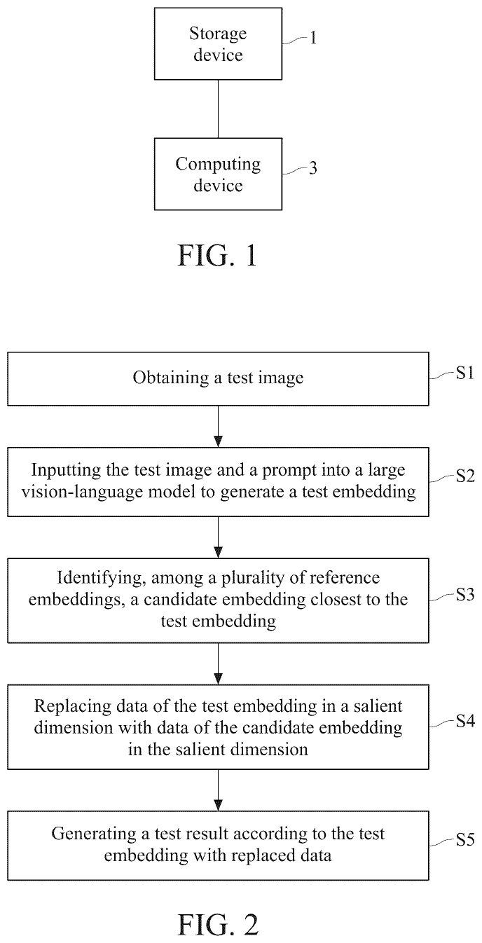

FIG. 1 is a block diagram of a system for reducing hallucinations generated by a large vision-language model according to an embodiment of the present disclosure. As shown in FIG. 1, the system includes a storage device 1 and a computing device 3.

The storage device 1 is configured to store a test image, a large vision-language model, and a plurality of reference embeddings.

In an embodiment, the storage device 1 may be implemented using at least one of the following hardware examples: flash memory, hard disk drive (HDD), solid-state drive (SSD), dynamic random-access memory (DRAM), static random-access memory (SRAM), or other non-volatile memories. However, the present disclosure is not limited to the above examples.

The test image may be any image, and the present disclosure imposes no limitation in this regard. In an embodiment, the large vision-language model may be InstructBLIP (Towards general purpose vision-language models with instruction tuning) and/or mPLUG-Owl2 (Revolutionizing multi-modal large language model with modality collaboration). The architecture of the large vision-language model is based on an autoregressive Transformer.

The computing device 3 is electrically connected to the storage device 1. The computing device 3 is configured to input the test image and a prompt into the large vision-language model to generate a test embedding. The prompt is a text configured to instruct the large vision-language model to describe the test image. The computing device 3 is configured to identify, among a plurality of reference embeddings, a candidate embedding closest to the test embedding, and to replace data of the test embedding in a salient dimension with data of the candidate embedding in the salient dimension. The computing device 3 then generates a test result from the test embedding with the replaced data using the large vision-language model. The following refers the test embedding with the replaced data as the modified test embedding.

In an embodiment, the computing device 3 may be implemented using at least one of the following hardware examples: a personal computer, network server, central processing unit (CPU), graphic processing unit (GPU), microcontroller unit (MCU), application processor (AP), field programmable gate array (FPGA), application-specific integrated circuit (ASIC), system-on-a-chip (SoC), deep learning accelerator, or any other electronic device with similar functions. The present disclosure imposes no limitation on the hardware type of the computing device 3.

FIG. 2 is a flowchart of a method for reducing hallucinations generated by a large vision-language model according to an embodiment of the present disclosure, comprising steps S1 to S5.

In step S1, the computing device 3 obtains a test image. In an embodiment, the computing device 3 may obtain the test image from the storage device 1 of the system local end or may obtain the test image in real time from outside the system when the computing device 3 is running the large vision-language model. The present disclosure imposes no limitation in this regard.

In step S2, the computing device 3 inputs the test image and a prompt into the large vision-language model to generate a test embedding. The test embedding is an intermediate output of the large vision-language model.

In step S3, the computing device 3 identifies, among a plurality of reference embeddings, a candidate embedding closest to the test embedding. In an embodiment, the L2-distance K-nearest neighbors approach is adopted: the L2 distance between each reference embedding and the test embedding is calculated, the K reference embeddings corresponding to the smallest K distances are selected, and the average of these K reference embeddings is calculated as the candidate embedding.

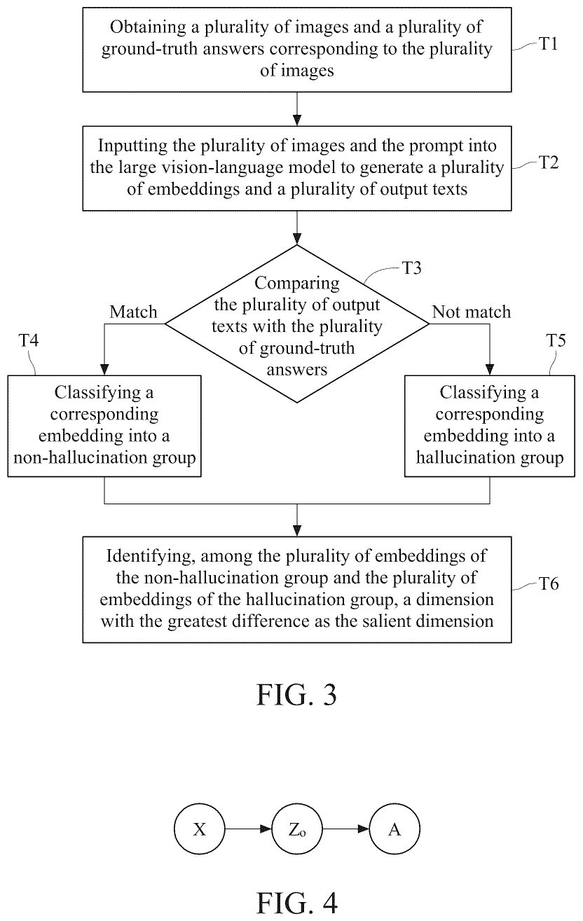

FIG. 3 is a flowchart for generating reference embeddings according to an embodiment of the present disclosure. This process is performed before step S3 and includes steps T1 to T6.

In step T1, the computing device 3 obtains a plurality of images and a plurality of ground-truth answers corresponding to the plurality of images. Each image includes a subject, and each ground-truth answer is configured to describe the subject. In an embodiment, the images and ground-truth answers are from the AMBER (An LLM-free multi-dimensional benchmark for MLLMs hallucination evaluation) dataset, which is a benchmark dataset for evaluating hallucinations in large vision-language models, containing human annotations on both truly appeared objects and potentially hallucinated ones.

In step T2, the computing device 3 inputs the plurality of images and the prompt into the large vision-language model to generate a plurality of embeddings and a plurality of output texts. The prompt is configured to instruct the large vision-language model to describe each image. Each embedding is an intermediate output of the large vision-language model based on the image and prompt, and each output text is an image description generated from the corresponding embedding.

In step T3, the computing device 3 compares the output text of each image with the ground-truth answer of the image. If they match, step T4 is performed; otherwise, step T5 is performed.

In step T4, a match between the output text and the ground-truth answer indicates that the output text does not mention any object that is not present in the image, implying that the large vision-language model did not generate hallucinations. Accordingly, the computing device 3 classifies the corresponding embedding of the current image into a non-hallucination group. The reference embeddings mentioned in step S3 are the embeddings belonging to the non-hallucination group. On the other hand, if the output text does not match the ground-truth answer, it indicates that the text includes objects not present in the image, meaning the large vision-language model generated hallucinations. Therefore, as described in step T5, the computing device 3 classifies the corresponding embedding of the current image into the hallucination group.

In step T6, the computing device 3 identifies a dimension with the greatest difference between the embeddings in the hallucination group and the non-hallucination group as the salient dimension. In an embodiment, the computing device 3 performs statistical analysis, such as Student's t-test, to examine each dimension between the two groups of embeddings, selects the dimensions with a p-value smaller than 0.001 and derives saliency maps indicating at least one salient dimension that distinguishes the hallucination group from the non-hallucination group in the dataset.

Returning to FIG. 2, in step S4, the computing device 3 replaces the data of the test embedding in the salient dimension with the data of the candidate embedding from the non-hallucination group in the same dimension. In step S5, the large vision-language model generates a test result according to the modified test embedding.

In an embodiment, the embedding editing method is as follows:

$${E}_{q}^{′} = ( 1 - ρ ) \cdot {E}_{q} + ρ \cdot M \cdot {E}_{K}$$

where E_{q} denotes the testing embedding, M∈ [symbol] ^{T×D} denotes the saliency map, E_{K} denotes the candidate embedding, ρ denotes a hyperparameter determining editing strength, E′_{q} denotes the modified testing embedding configured to generate the test result.

The core of the present disclosure lies in reducing hallucination in large vision-language models through causal intervention. The specific steps of the embodiment of “embedding intervention” have been described previously. In addition, the present disclosure further includes embodiments of “image intervention” and “text intervention”. Before explaining the detailed steps of these two embodiments, please refer to FIG. 4 to FIG. 8.

The directed acyclic graph (DAG) in the figures represents the causal graph model, including the test image I, prompt Q, latent variable Zₒ of the target object, context factor Z_{c}, and the final testing result. The directed edges between variables indicates a direct causal influence of the parent node on the child node. The present disclosure distinguishes and abstracts variables Zₒ and Z_{c} at the cognitive level. Zₒ represents the ideal semantic representation of target objects (e.g., the concept of a car), while Z_{c} as a confounding variable denotes a context pattern that could diversify the comprehension of the car. Herein, Z_{c} is regarded as the hallucination triggers.

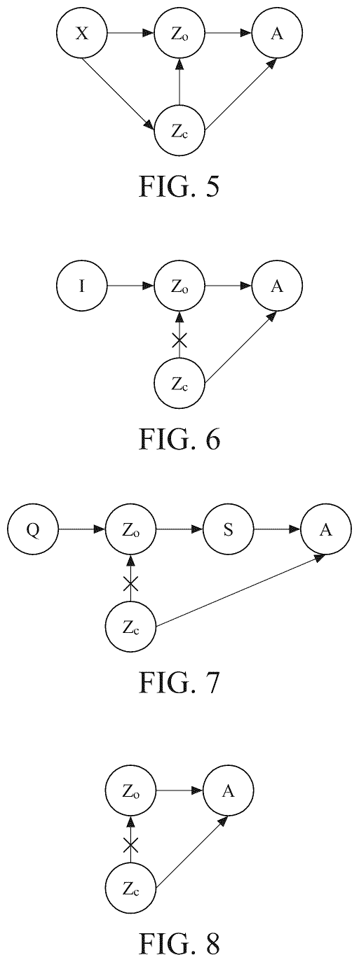

FIG. 4 is a schematic diagram of the ideal output of a large vision-language model, where A is independent of Z_{c}. However, as shown in FIG. 5, the inherent bias in the training data introduces Z_{c} into the causal graphical model of the large vision-language model, shaping the unwanted causal effect Z_{c}→Zₒ. Therefore, the present disclosure proposes three embodiments, “image intervention”, “text intervention”, and “embedding intervention”, to block the path Z_{c}→Zₒ. Their schematic diagrams correspond to FIG. 6 through FIG. 8, respectively. It is important to note that these three embodiments may operate in combination or independently and the present disclosure does not limit this.

The “image intervention” embodiment includes two approaches: pasting a small object in the background of the test image and removing a hallucinatory-inducing object from the test image. The specific steps of the first approach are as follows: before inputting the test image and the prompt into the large vision-language model to generate the test embedding, pasting a small image on an edge of the test image, wherein the small image is smaller than the test image in size, the small image is positioned away from the subject, and a content of the small image is semantically unrelated to the subject. For example, pasting a small image featuring a single object, sized to one-sixth of the shortest side of the test image, at the top left corner of the test image to ensure the object is recognizable and in the background, implicitly affecting Zₒ.

The second approach removes one hallucinatory-inducing object in the test image based on the highest hallucinatory frequency. For example, removing a “car” because it may lead to a hallucination of a “road.” In an embodiment, the computing device 3 uses the combination of Grounding DINO (Marrying DINO with grounded pre-training for open-set object detection) and IA (Inpaint Anything: Segment Anything meets image inpainting) to detect and segment the object and then fill the masked area using the inpainting technique.

The embodiment of “text intervention” is as follows: before inputting the test image and the prompt into the large vision-language model to generate the test embedding, adding a command in the prompt to instruct the large vision-language model to separately describe a foreground and a background of the test image. The text intervention includes two steps, separately prompting for the foreground (FG) and background (BG) generation. These two prompting steps are carried out by introducing an intermediate variable S, as shown in FIG. 7. First, the large vision-language model is instructed to describe the foreground subject, and this description is then used as a prompt for further describing additional details in the background. Specifically, the prompt “Describe the foreground and ignore the background in the image” is used to obtain the foreground description A_{f}. Afterwards, the prompt is modified to “Given that the foreground is [A_{f}], describe the other contents in the background.”

The present disclosure aims to reduce hallucination in large vision-language models efficiently, without requiring model retraining or iterative inference. Specifically, the present disclosure proposes to systematically observe the causal relationships within the image and block the effects of hallucination triggers by intervening in the causal graph. This intervention is implemented by replacing part of the input and does not significantly increase inference time. The proposed method and system directly intervene in identified hallucination-triggering factors, thereby reducing hallucinated object detection and repeated generation. Compared with prior methods that focus solely on removing hallucinated objects after generation, the proposed method and system capture and alter the source of hallucination-inducing influence before the generation process.

In summary, the present disclosure proposes a method and system aimed at reducing hallucination in LVLMs in an efficient manner without model retraining and iterative inferencing. The present disclosure blocks the effects of hallucinatory triggers by intervention of the causal graph. This intervention is implemented as a replacement of the partial inputs, this intervention barely increases the inference time. The method and system proposed by the present disclosure directly intervenes the identified aspects of hallucination triggers, and thus mitigates hallucinatory object detection and multiple rounds of repeated generation. In contrast to previous works that focusing on eliminating the generated hallucinatory objects, the present disclosure captures the potential influential sources to hallucination and changes the generation process beforehand.

What is claimed is:

1. A method for reducing hallucinations generated by a large vision-language model, comprising a plurality of steps performed by a computing device, with the plurality of steps comprising
obtaining a test image;
inputting the test image and a prompt into the large vision-language model to generate a test embedding, wherein the prompt is configured to instruct the large vision-language model to describe the test image;
identifying, among a plurality of reference embeddings, a candidate embedding closest to the test embedding;
replacing data of the test embedding in a salient dimension with data of the candidate embedding in the salient dimension; and
generating a test result by the large vision-language model according to the test embedding with replaced data.

2. The method for reducing hallucinations generated by the large vision-language model of claim 1, further comprising, before replacing the data of the test embedding in the salient dimension with the data of the candidate embedding in the salient dimension:
obtaining a plurality of images and a plurality of ground-truth answers corresponding to the plurality of images, wherein each of the plurality of images comprises a subject, and each of the plurality of ground-truth answers is configured to describe the subject;
inputting the plurality of images and the prompt into the large vision-language model to generate a plurality of embeddings and a plurality of output texts, wherein the prompt is configured to instruct the large vision-language model to describe each of the plurality of images;
comparing the plurality of output texts with the plurality of ground-truth answers;
classifying a corresponding one of the plurality of embeddings into a non-hallucination group when one of the plurality of output texts matches one of the plurality of ground-truth answers, wherein the plurality of reference embeddings are the plurality of embeddings in the non-hallucination group;
classifying a corresponding one of the plurality of embeddings into a hallucination group when one of the plurality of output texts does not match any of the plurality of ground-truth answers; and
identifying, among the plurality of embeddings of the non-hallucination group and the plurality of embeddings of the hallucination group, a dimension with a greatest difference as the salient dimension.

3. The method for reducing hallucinations generated by the large vision-language model of claim 2, wherein identifying, among the plurality of embeddings of the non-hallucination group and the plurality of embeddings of the hallucination group, the dimension with the greatest difference as the salient dimension is performed by a Student's t-test.

4. The method for reducing hallucinations generated by the large vision-language model of claim 2, further comprising, before inputting the test image and the prompt into the large vision-language model to generate the test embedding: pasting a small image on an edge of the test image, wherein the small image is smaller than the test image in size, the small image is positioned away from the subject, and a content of the small image is semantically unrelated to the subject.

5. The method for reducing hallucinations generated by the large vision-language model of claim 1, further comprising, before inputting the test image and the prompt into the large vision-language model to generate the test embedding: instructing the large vision-language model to separately describe a foreground and a background of the test image by using the prompt.

6. A system for reducing hallucinations generated by a large vision-language model, comprising:
a storage device configured to store a test image, the large vision-language model, and a plurality of reference embeddings; and
a computing device electrically connected to the storage device, wherein the computing device is configured to input the test image and a prompt into the large vision-language model to generate a test embedding, the prompt is configured to instruct the large vision-language model to describe the test image, the computing device is further configured to identify, among the plurality of reference embeddings, a candidate embedding closest to the test embedding, to replace data of the test embedding in a salient dimension with data of the candidate embedding in the salient dimension, and to generate a test result by the large vision-language model according to the test embedding with replaced data.

7. The system for reducing hallucinations generated by a large vision-language model of claim 6, wherein the computing device is further configured to:
before replacing the data of the test embedding in the salient dimension with the data of the candidate embedding in the salient dimension, obtain a plurality of images and a plurality of ground-truth answers corresponding to the plurality of images, wherein each of the plurality of images comprises a subject, each of the plurality of ground-truth answers in configured to describe the subject;
input the plurality of images and the prompt into the large vision-language model to generate a plurality of embeddings and a plurality of output texts, wherein the prompt is configured to instruct the large vision-language model to describe each of the plurality of images;
compare the plurality of output texts with the plurality of ground-truth answers;
classify a corresponding one of the plurality of embeddings into a non-hallucination group when one of the plurality of output texts matches one of the plurality of ground-truth answers, wherein the plurality of reference embeddings are the plurality of embeddings in the non-hallucination group;
classify a corresponding one of the plurality of embeddings into a hallucination group when one of the plurality of output texts does not match any of the plurality of ground-truth answers; and
identify, among the plurality of embeddings of the non-hallucination group and the plurality of embeddings of the hallucination group, a dimension with a greatest difference as the salient dimension.

8. The system for reducing hallucinations generated by a large vision-language model of claim 7, wherein the computing device is configured to perform a Student's t-test to identify, among the plurality of embeddings of the non-hallucination group and the plurality of embeddings of the hallucination group, the dimension with the greatest difference as the salient dimension.

9. The system for reducing hallucinations generated by a large vision-language model of claim 7, wherein the computing device is further configured to: before inputting the test image and the prompt into the large vision-language model to generate the test embedding, paste a small image on an edge of the test image, wherein the small image is smaller than the test image in size, the small image is positioned away from the subject, and a content of the small image is semantically unrelated to the subject.

10. The system for reducing hallucinations generated by a large vision-language model of claim 6, wherein the computing device is further configured to:
before inputting the test image and the prompt into the large vision-language model to generate the test embedding, instruct the large vision-language model to separately describe a foreground and a background of the test image by using the prompt.
